(19) United States
(12) Patent Application Publication
(10) Pub. No.: US 2026/0351855 A1
(43) Pub. Date: Nov. 5, 2026

(54) Antenna System for a Portable Information Handling System

(71) Applicant: Dell Products L.P., Round Rock, TX (US)

(72) Inventor: Ching-Cheng Hsu, Shilin (TW)

(21) Appl. No.: 19/198,348

(22) Filed: May 5, 2025

(51) Int. Cl. H01Q 13/10; H01Q 5/20

(52) U.S. Cl. CPC H01Q 13/10; H01Q 5/20

(57) ABSTRACT

An antenna system for a portable information handling system. The antenna system includes an antenna aperture, the antenna aperture horizontally extending between hinges of the portable information handling system; and, an antenna component, the antenna component horizontally extending across a portion of the antenna aperture, the antenna aperture and the antenna component being configured as a slot antenna.

### BACKGROUND OF THE INVENTION

### Field of the Invention

The present invention relates to information handling systems. More specifically, embodiments of the invention relate to an antenna system for a portable information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to an antenna system for a portable information handling system, comprising: an antenna aperture, the antenna aperture horizontally extending between hinges of the portable information handling system; and, an antenna component, the antenna component horizontally extending across a portion of the antenna aperture, the antenna aperture and the antenna component being configured as a slot antenna.

In another embodiment the invention relates to an information handling system comprising: a processor; a data bus coupled to the processor; and a chassis housing, the chassis housing comprising a base chassis, the base chassis housing the processor; and a display chassis, the base chassis and the display chassis being attached via a plurality of hinges; and, an antenna system coupled to the processor, the antenna system comprising an antenna aperture, the antenna aperture horizontally extending between the plurality of hinges; and, an antenna component, the antenna component horizontally extending across a portion of the antenna aperture, the antenna aperture and the antenna component being configured as a slot antenna.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a perspective view of an example portable information handling system.

FIG. 3 shows a blown-up view of a portable information handling system.

FIGS. 4A, 4B, 4C and 4D, generally referred to as FIG. 4, show views of a portable information handling system having an integrated antenna system.

FIGS. 5A, 5B, 5C, 5D, 5E, 5F and 5G, generally referred to as FIG. 5, shows views of an integrated antenna system of a portable information handling system.

FIGS. 6A, 6B, 6C, 6D, 6E, 6F and 6G, generally referred to as FIG. 6, shows views of an integrated antenna system of a portable information handling system.

FIG. 7 shows an example performance result of an integrated antenna system.

FIG. 8 shows an example performance result of an integrated antenna system.

FIGS. 9A, 9B and 9C, generally referred to as FIG. 9, show example current distributions generated by an integrated antenna system.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Various aspects of the present disclosure include an appreciation that it is known to provide portable information handling systems with antenna systems for a variety of different radio frequencies. Various aspects of the present disclosure include an appreciation that many known portable information handling systems now include cellular communication capabilities in addition to WiFi communication capabilities. For the purposes of this disclosure, radio frequency (RF) refers to a frequency or band of frequencies suitable for use in wireless communication.

Various aspects of the present disclosure include an appreciation that cellular communication capabilities often require a relatively large aperture (often referred to as an antenna window) through which the antenna radio signal passes due to the application for a lower frequency band at 700~1000 MHz. Various aspects of the present disclosure include an appreciation that industrial design constraints can often restrict the size of the antenna aperture as portable information handling system industrial designs often include metal A and D covers which preclude inclusion of plastic antenna apertures.

Various aspects of the present disclosure include an appreciation that it would be desirable to provide a portable information handling system antenna system which addresses the antenna radiation blockage issue (e.g., via metal housing components) while also accommodating industrial design constraints.

A system and method are disclosed for providing an antenna system within a portable information handling system. In various embodiments, the antenna system comprises an antenna component and an antenna aperture. In various embodiments, the antenna component includes an antenna radiator and an antenna carrier. In certain embodiments, the antenna radiator is mounted on the antenna carrier. In certain embodiments, the antenna radiator functions as an excitor which feeds the radio frequency signal to the aperture. In certain embodiments, the antenna radiator and the aperture are configured as slot antenna. In certain embodiments, the antenna radiator and the aperture are configured as a low band (substantially (i.e., +/−20%) 700-1000 MHz) antenna. In certain embodiments, the resonant frequency of antenna system can be adjusted by changing the distance between hinges, by changing the antenna type, by changing the antenna location, or a combination thereof.

In certain embodiments, the aperture is defined by portions of an A cover and a D cover of the portable information handling system. In certain embodiments, the A cover and the D cover are form from metal. In certain embodiments, the A cover defines a top edge of the aperture, and the D cover defines side edges of the aperture and a bottom edge of the aperture. In certain embodiments, an area defined by the aperture is larger than a cross-sectional area of the antenna radiator. In certain embodiments, the antenna system is mounted between hinges of the portable information handling system. In certain embodiments, the aperture extends substantially between interior edges of the hinges of the portable information handling system. In certain embodiments, the antenna radiator and the antenna carrier occupy about half of the area of the aperture.

In certain embodiments, the antenna system advantageously reduces the cellular antenna design area due to the aperture being included with the antenna system. In certain embodiments, the antenna system advantageously releases space within the portable information handling system base to be used for other components such as a larger battery, additional electronics, a larger acoustic chamber, etc. In certain embodiments, the antenna system advantageously functions with a long-term evolution (LTE) type low band application (substantially (i.e., +/−20%) 700-1000 MHz). In certain embodiments, the antenna system advantageously enhances antenna efficiency due to a relatively large cross-section area of the aperture.

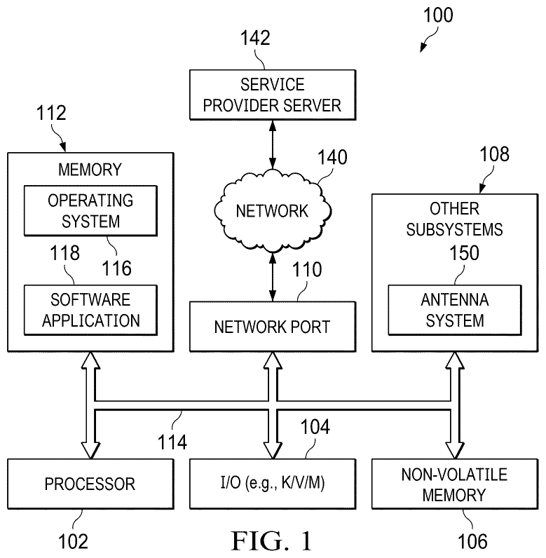

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise at least one software application 118. In one embodiment, the information handling system 100 is able to download the software application from the service provider server 142. In another embodiment, the software application 118 is provided as a service from the service provider server 142.

In certain embodiments, the information handling system includes an antenna system 150. In various embodiments, the antenna system 150 includes an antenna component and an antenna aperture. In various embodiments, the antenna component includes an antenna radiator and an antenna carrier. In certain embodiments, the antenna radiator is mounted on the antenna carrier. In certain embodiments, the antenna radiator functions as an excitor which feeds a radio frequency (RF) signal to the aperture. In certain embodiments, the antenna radiator and the aperture are configured as slot antenna. As used herein, a slot antenna broadly refers to an antenna which includes a radiating element and a slot (i.e., an aperture) formed in a conductive surface such that when a radio frequency is applied to the slot by the radiating element, the slot radiates electromagnetic waves. In certain embodiments, the antenna radiator and the aperture are configured as a low band (substantially (i.e., +/−20%) 700-1000 MHz) antenna. In certain embodiments, the resonant frequency of antenna system can be adjusted by changing the distance between hinges, by changing the antenna type, by changing the antenna location, or a combination thereof.

In certain embodiments, the aperture is defined by portions of an A cover and a D cover of the portable information handling system. In certain embodiments, the A cover and the D cover are form from metal. In certain embodiments, the A cover defines a top edge of the aperture. and the D cover defines side edges of the aperture and a bottom edge of the aperture. In certain embodiments, an area defined by the aperture is larger than a cross-sectional area of the antenna radiator. In certain embodiments, the antenna system is mounted between hinges of the portable information handling system. In certain embodiments, the aperture extends substantially between interior edges of the hinges of the portable information handling system. In certain embodiments, the antenna radiator and the antenna carrier occupy about half of the area of the aperture.

In certain embodiments, the antenna system advantageously reduces the cellular antenna design area due to the aperture being included with the antenna system. In certain embodiments, the antenna system advantageously releases space within the portable information handling system base to be used for other components such as a larger battery, additional electronics, a larger acoustic chamber, etc. In certain embodiments, the antenna system advantageously functions with a long-term evolution (LTE) type low band application (substantially (i.e., +/−20%) 700-1000 MHz). In certain embodiments, the antenna system advantageously enhances antenna efficiency due to a relatively large cross section area of the aperture.

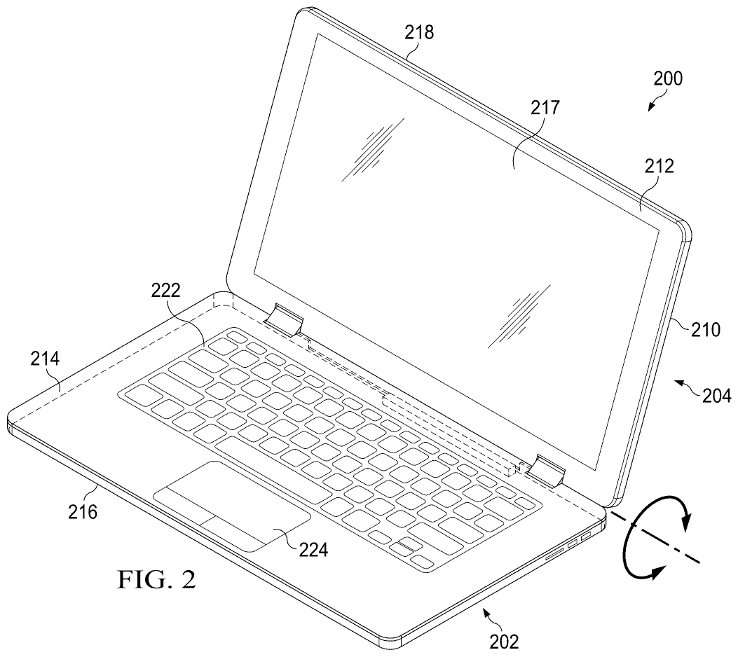

FIG. 2 shows a perspective view of an example portable information handling system chassis 200 such as a tablet type portable information handling system, a laptop type portable information handling system, or any other mobile information handling system. It will be appreciated that some or all of the components of the information handling system 100 may be included within information handling system chassis 200. The portable information handling system 200 chassis includes a base chassis 202 and a display chassis 204 shown in an open configuration. It will be appreciated that a closed configuration would have the display chassis 204 fully closed onto the base chassis 202.

The base chassis 202 or the display chassis 204 of the information handling system 200 may comprise an outer metal case or shell. The information handling system 200 may include a plurality of chassis portions. In various embodiments, the information handling system 200 may include some or all of an A-Cover 210, a B-Cover 212, a C-cover 214 and a D-Cover 216. In various embodiments, the A-Cover 210 and the B-Cover 212 provide the display chassis 204. In various embodiments, the C-Cover 214 and the D-Cover 216 provide the base chassis 202.

In various embodiments, the A-cover 210 encloses a portion of the display chassis 204 of the information handling system 200. In various embodiments, the B-cover 212 encloses another portion of the display chassis 204 of the information handling system 200. In various embodiments, the B-Cover may include a display screen 217 and a bezel 218 around the display screen.

In various embodiments, the C-cover 214 encloses a portion of the base chassis 202 of the information handling system 200. In various embodiments, the C-cover 214 may include, for example, a keyboard 222, a trackpad 224, or other input/output (I/O) device. In various embodiments, certain components of the information handling system such as a mother board are mounted within the C-Cover 214. In various embodiments, the D-cover 216 encloses another portion of the base chassis 202 of the information handling system 200.

When placed in the closed configuration, the A-cover 202 forms a top outer protective shell, or a portion of a lid, for the information handling system 200, while the D-cover 204 forms a bottom outer protective shell, or a portion of a base, for the information handling system. When in the fully closed configuration, the A-cover 202 and the D-cover 204 would be substantially parallel to one another.

In some embodiments, both the A-cover 202 and the D-cover 204 may be comprised entirely of metal. In some embodiments, the A-cover 202 and D-cover 204 may include both metallic and plastic components. For example, plastic components that are radio-frequency (RF) transparent may be used to form a portion of the C-cover 208.

In various embodiments, the A-cover 202 may be movably connected to a back edge of the D-cover 204 via one or more hinges. In this configuration, the hinges allow the A-cover 202 to rotate from and to the D-cover 204 allowing for multiple orientations of the information handling system 200. In various embodiments, the information handling system may include a sensor to detect the orientation of the information handling system and activate or deactivate any number of antenna systems based on the occurrence of any specific orientation. In some embodiments, the information handling system may be a laptop with limited rotation of the A-cover 204 with regard to the D-cover 204, for example up to 180° rotation arc. In other embodiments the information handling system 200 may be a convertible information handling system with full rotation to a tablet configuration.

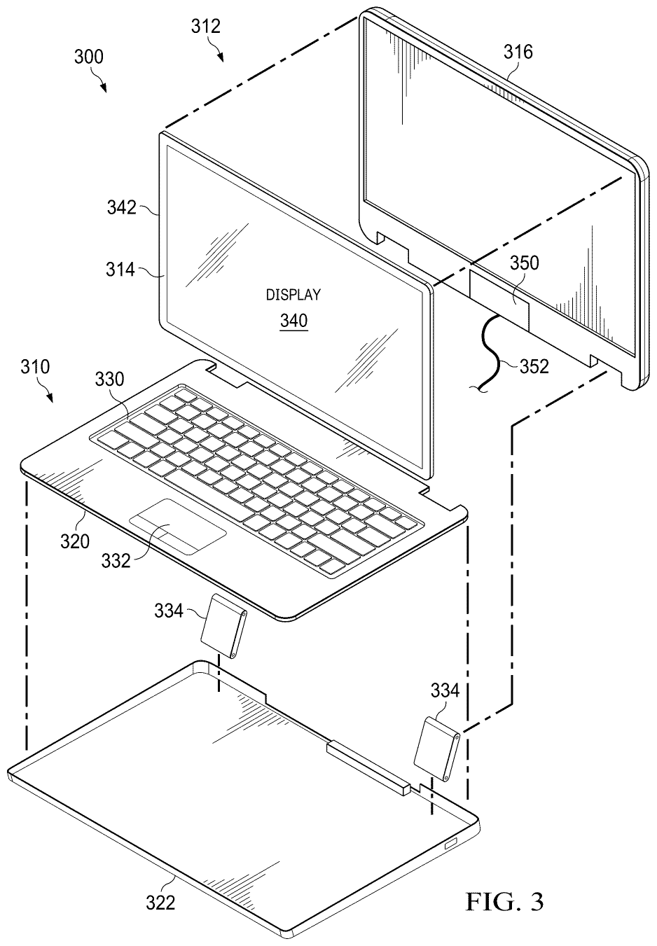

FIG. 3 shows a blown-up view of a portable information handling system 300 having rotationally-coupled housing portions. In the example embodiment, a main housing portion 310 (which corresponds to a base chassis 202) rotationally couples to a lid housing portion 312 (which corresponds to a display chassis 204) to support various configurations to interact with an end user. Main housing portion 310 may hold one or more components of the portable information handling system, including but not limited to processor 102, system bus 114, memory subsystem 112, I/O subsystem 104 and network interface 110 discussed with respect to FIG. 1. Main housing portion 310 includes a top cover portion 320 (which includes the C-Cover 214) and a bottom cover portion 322 (which includes the D-Cover 216). Lid housing portion 312 includes a display cover portion 314 (which includes the B-Cover 210) and a rear display cover portion 316 (which includes the A-Cover 212). The top cover portion 320 may include an integrated keyboard 330 or other I/O devices, such as a trackpad 332 or microphone (not shown). In various embodiments, the keyboard 330 may be mounted to the top of the C-Cover of the main housing portion 310. In various embodiments, the keyboard 330 may be mounted to the underside of the C-Cover of the main housing portion 310.

Lid housing portion 312 is rotationally coupled to main housing portion 310 via at least one hinge assembly 334. Lid housing portion 212 includes display 340 that visually presents information to the user as well as a bezel 342. Display 340 may be a touch panel with circuitry enabling touch functionality in conjunction with a display. In some embodiments, display 340 may be an “infinity edge” or “narrow bezel” display that approaches one or more the edges of lid housing portion 212 such that bezel may be narrow in size (e. g., less than 10 millimeters) on the edges. For example, display 340 is an infinity display with narrow bezels on the top and sides of lid housing portion 212 in the embodiment shown in FIG. 3. In certain embodiments, the side bezel is less than 4 mm (+/−10%) and the top bezel is less than 6 mm (+/−10%).

Lid housing portion 212 may also include timing controller (TCON) 350. Hinge assembly 330 may include cable 352 for communicably coupling one or more components within main housing portion 310 to one or more components within lid housing portion 312. For example, cable 352 may provide communication of graphics information from an I/O subsystem to TCON 350 for generation of visual images for display on display 340. Although a single cable 352 is shown, portable information handling system 300 may include one or more additional cables 352 for communicating components disposed in main housing portion 310 and lid housing portion 312. Placement of cable 352 may be selected based on design considerations, materials or manufacturing cost, material reliability, antenna placement, as well as any other considerations.

Hinge assembly 334 allows main housing portion 310 and lid housing portion 312 to rotate between a plurality of positions. For example, when portable information handling system 300 is not in use, lid housing portion 312 may be closed over the top of main portion 310 such that display 340 and keyboard 330 are protected from unintended use or damage. Rotation of lid housing portion 312 by approximately 90 degrees from main housing portion 310 brings display 340 in a raised “clamshell” position relative to keyboard 330 so that an end user can make inputs to keyboard 330 or touch panel portion of display 340 while viewing display 340. In some embodiments, clamshell position may represent lid housing portion 212 open between approximately 1 and 180 degrees from main housing portion 310. Rotation of lid housing portion 312 between approximately 180 and 359 degrees from main housing portion 310 may place portable information handling system 300 in “tablet stand” and/or “tent” positions. In tablet stand and tent positions, the user may make inputs via touch panel portion of display 340 while viewing display 340. A full 360 degree rotation of main housing portion 310 relative to lid housing portion 312 provides a tablet configuration having display 340 exposed to accept touch inputs. In any position, user inputs may be communicated to an I/O subsystem or a processor of the portable information handling system 300 for processing, and then updated information may be communicated back via cable 352 to display 340 for displaying to the user. Hinge assembly 334 may be comprised of one or more discrete hinges or a unified assembly of hinges.

In certain embodiments, the information handling system includes an antenna system 350. In various embodiments, the antenna system 350 includes an antenna component and an antenna aperture. In various embodiments, the antenna component includes an antenna radiator and an antenna carrier. In certain embodiments, the antenna radiator is mounted on the antenna carrier. In certain embodiments, the antenna radiator functions as an excitor which feeds a radio frequency (RF) signal to the aperture. In certain embodiments, the antenna radiator and the aperture are configured as slot antenna. In certain embodiments, the antenna radiator and the aperture are configured as a low band (substantially (i.e., +/−20%) 700-1000 MHz) antenna. In certain embodiments, the resonant frequency of antenna system can be adjusted by changing the distance between hinges, by changing the antenna type, by changing the antenna location, or a combination thereof.

In certain embodiments, the aperture is defined by portions of an A cover and a D cover of the portable information handling system. In certain embodiments, the A cover and the D cover are form from metal. In certain embodiments, the A cover defines a top edge of the aperture, and the D cover defines side edges of the aperture and a bottom edge of the aperture. In certain embodiments, an area defined by the aperture is larger than a cross-sectional area of the antenna radiator. In certain embodiments, the antenna system is mounted between hinges of the portable information handling system. In certain embodiments, the aperture extends substantially between interior edges of the hinges of the portable information handling system. In certain embodiments, the antenna radiator and the antenna carrier occupy about half of the area of the aperture.

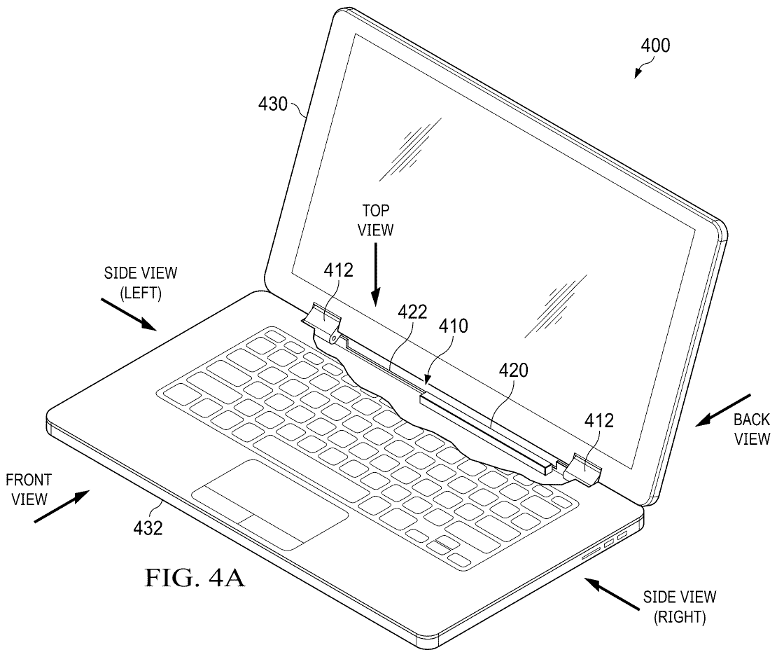

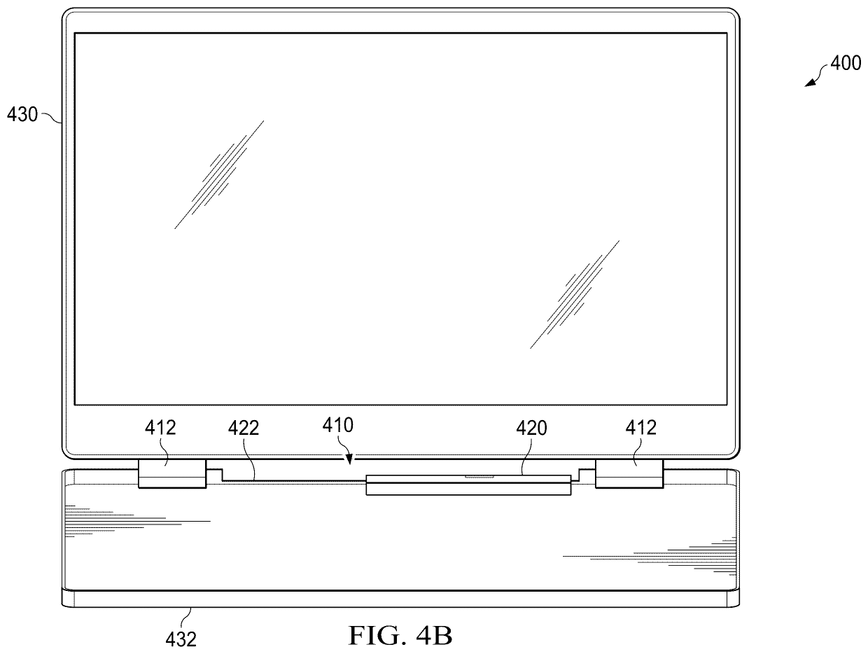

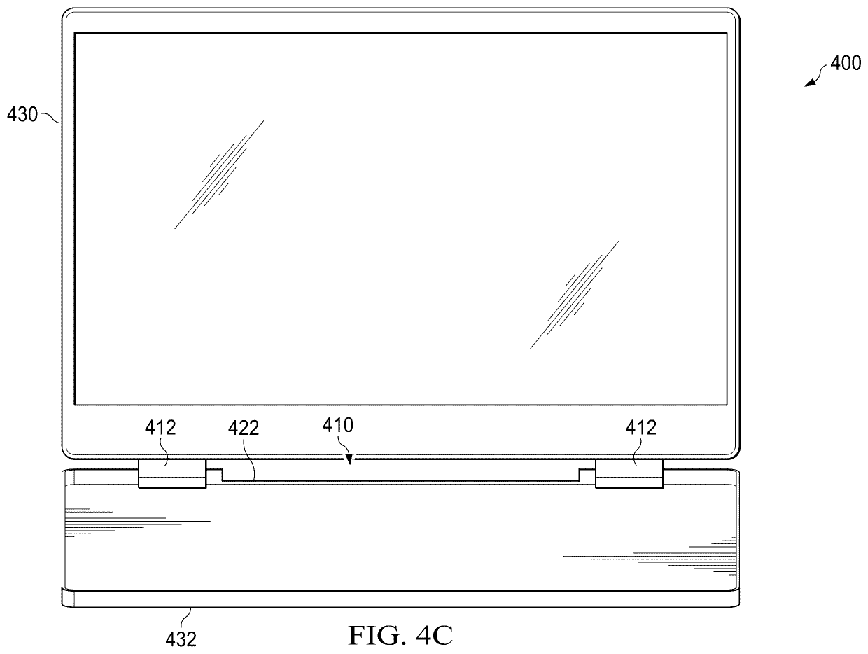

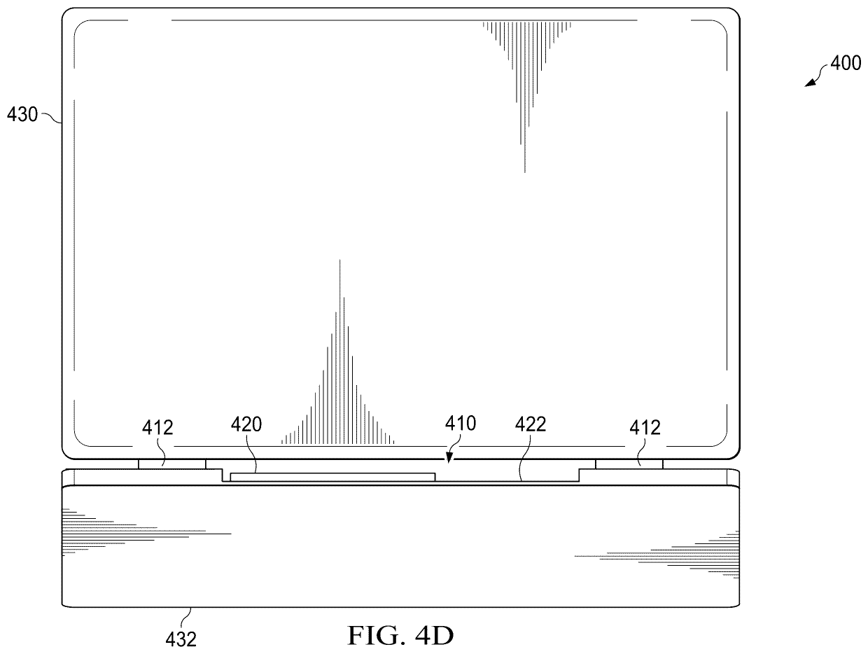

FIGS. 4A, 4B, 4C and 4D, generally referred to as FIG. 4, show views of a portable information handling system 400 having an antenna system 410. More specifically, FIG. 4A shows a perspective view of a portable information handling system having an integrated antenna system. FIG. 4B shows a front view of a portable information handling system having an integrated antenna system. FIG. 4C shows a front view of a portable information handling system showing an antenna system aperture. FIG. 4D shows a rear view of a portable information handling system having an integrated antenna system.

In various embodiments, the antenna system 410 includes an antenna component 420 and an antenna aperture 422. In various embodiments, the antenna component includes an antenna radiator and an antenna carrier. In certain embodiments, the antenna radiator is mounted on the antenna carrier. In certain embodiments, the antenna radiator functions as an excitor which feeds a radio frequency (RF) signal to the aperture. In certain embodiments, the antenna component 420 and the antenna aperture 422 are configured as slot antenna. In certain embodiments, the antenna component 420 and the antenna aperture 422 are configured as a low band (substantially (i.e., +/−20%) 700-1000 MHz) antenna. In certain embodiments, the resonant frequency of antenna system can be adjusted by changing the distance between hinges, by changing the antenna type, by changing the antenna location, or a combination thereof.

In certain embodiments, the antenna aperture 422 is defined by portions of an A cover 430 and a D cover 432 of the portable information handling system. In certain embodiments, the A cover 430 and the D cover 432 are formed from metal. In certain embodiments, the A cover 430 defines a top edge of the antenna aperture 422 and the D cover 432 defines side edges of the antenna aperture 422, a bottom edge of the antenna aperture 422, or a combination thereof. In certain embodiments, an area defined by the aperture is larger than a cross-sectional area of the antenna radiator. In certain embodiments, the antenna system 410 is mounted between hinges 412 of the portable information handling system 400. In certain embodiments, the antenna aperture 422 extends substantially between interior edges of the hinges 412 of the portable information handling system 400. In certain embodiments, the antenna component 420 occupies about half of the cross-sectional area of the antenna aperture 422. In certain embodiments, the antenna radiator and the antenna carrier occupy about half of the cross-sectional area of the antenna aperture 422.

In certain embodiments, the antenna aperture is substantially (i.e., +/−20%) 170 mm wide. In certain embodiments, the antenna aperture is substantially (i.e., +/−20%) substantially (i.e., +/−20%) 3.8 mm tall. In certain embodiments, the antenna aperture is substantially (i.e., +/−20%) 2.0 mm deep.

In certain embodiments, the antenna component 420 is spaced substantially (i.e., +/−20%) 2.0 mm from the rear of the antenna aperture 422. In certain embodiments, the height of the antenna component 420 substantially (i.e., +/−20%) corresponds to an inside bottom edge of the display chassis when the display chassis is in an angled open orientation. In certain embodiments, the antenna component 420 is substantially (i.e., +/−20%) 6.0 mm tall and substantially (i.e., +/−20%) 6 mm deep. In certain embodiments, the width of the antenna component 420 is substantially (i.e., +/−20%) half of the width of the antenna aperture 422. In certain embodiments, the antenna carrier is substantially (i.e., +/−20%) 85 mm wide. In certain embodiments, the antenna radiator is substantially (i.e., +/−20%) 60 mm wide.

In certain embodiments, the antenna component 420 is positioned to substantially (i.e., +/−20%) correspond to a side of the antenna aperture 422. In certain embodiments, the antenna component 420 is positioned to substantially (i.e., +/−20%) correspond to a right side of the antenna aperture. In certain embodiments, the antenna component is positioned to substantially (i.e., +/−20%) occupy a half side of the antenna aperture. In certain embodiments, the antenna component is positioned to excite the antenna aperture at the desired frequency band. In certain embodiments, the desired frequency band is substantially (i.e., +/−20%) 700-1000 MHz.

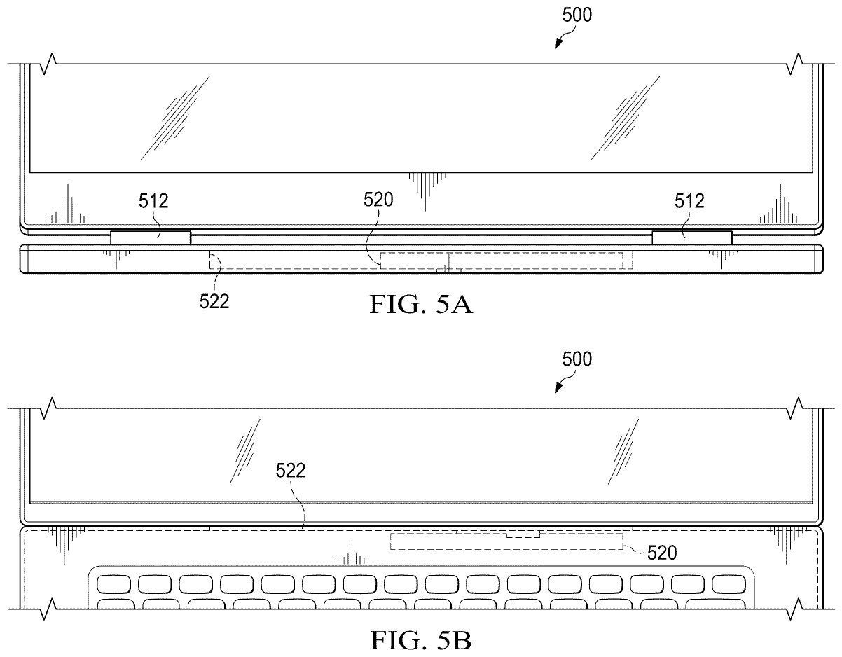

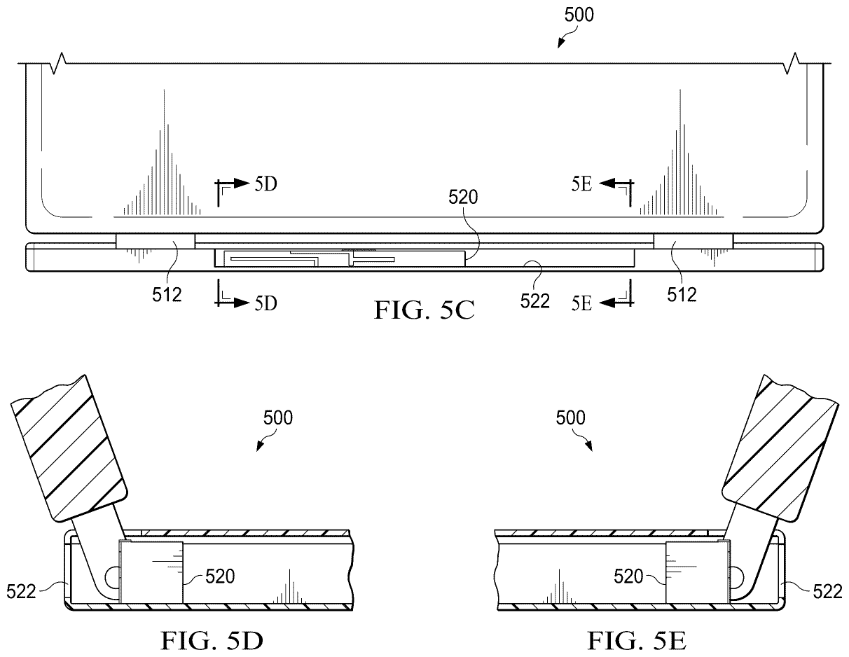

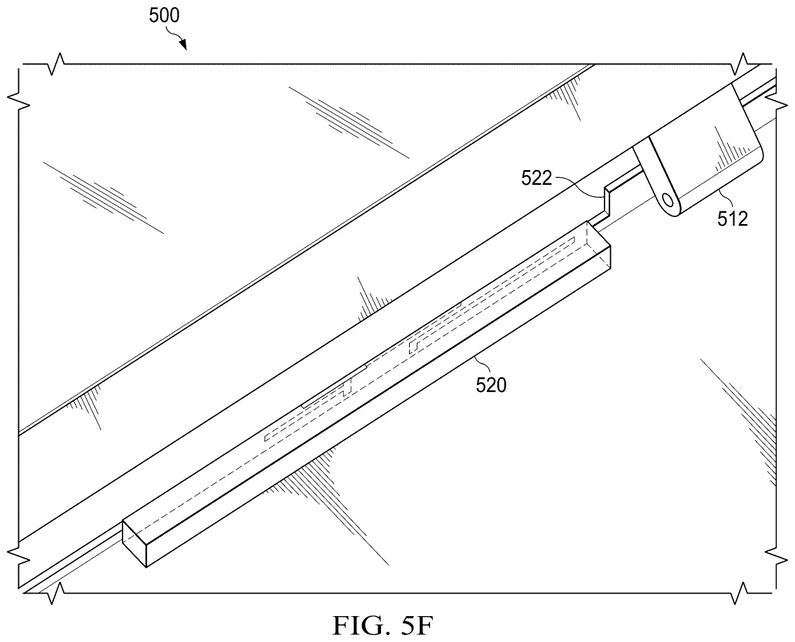

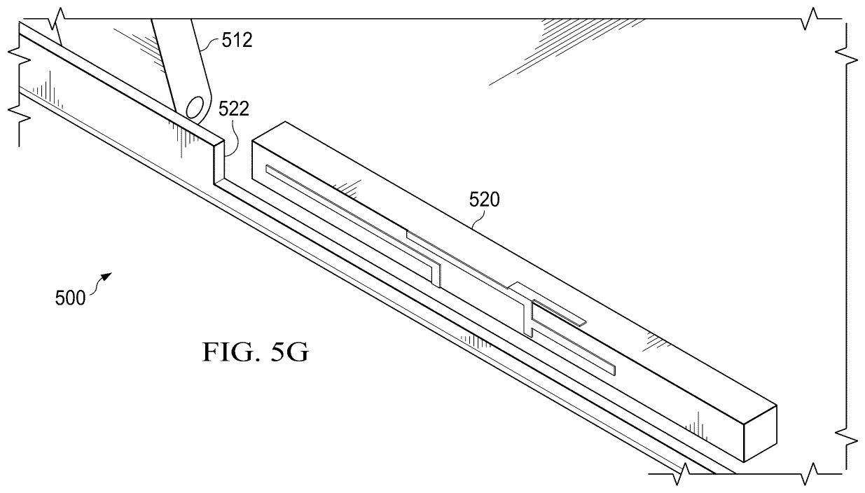

FIGS. 5A, 5B, 5C, 5D, 5E, 5F and 5G, generally referred to as FIG. 5, shows views of a portable information handling system with an antenna system. More specifically, FIG. 5A shows a front view of a portable information handling system with an antenna system. FIG. 5B shows a top view of a portable information handling system with an antenna system. FIG. 5C shows a rear view of a portable information handling system with an antenna system. FIG. 5D shows a left side view of a portable information handling system with an antenna system. FIG. 5E shows a right side view of a portable information handling system with an antenna system. FIG. 5F shows a top rear perspective view of a portable information handling system with an antenna system. FIG. 5G shows a top front perspective view of a portable information handling system with an antenna system. In certain embodiments, the antenna system 505 corresponds to antenna system 150.

In various embodiments, the antenna system 505 includes an antenna component 520 and an antenna aperture 522. In various embodiments, the antenna component includes an antenna radiator and an antenna carrier. In certain embodiments, the antenna radiator is mounted on the antenna carrier. In certain embodiments, the antenna radiator functions as an excitor which feeds a radio frequency (RF) signal to the aperture. In certain embodiments, the antenna component 520 and the antenna aperture 522 are configured as slot antenna. In certain embodiments, the antenna component 520 and the antenna aperture 522 are configured as a low band (substantially (i.e., +/−20%) 700-1000 MHz) antenna. In certain embodiments, the resonant frequency of antenna system can be adjusted by changing the distance between hinges, by changing the antenna type, by changing the antenna location, or a combination thereof.

In certain embodiments, the antenna aperture 522 is defined by portions of an A cover 530 and a D cover 532 of the portable information handling system. In certain embodiments, the A cover 530 and the D cover 532 are formed from metal. In certain embodiments, the A cover 530 defines a top edge of the antenna aperture 522, and the D cover 532 defines side edges of the antenna aperture 522, a bottom edge of the antenna aperture 522, or a combination thereof. In certain embodiments, an area defined by the aperture is larger than a cross-sectional area of the antenna radiator. In certain embodiments, the antenna system 505 is mounted between hinges 512 of the portable information handling system 500. In certain embodiments, the antenna aperture 522 extends substantially between interior edges of the hinges 512 of the portable information handling system 500. In certain embodiments, the antenna component 520 occupies about half of the cross-sectional area of the antenna aperture 522. In certain embodiments, the antenna radiator and the antenna carrier occupy about half of the cross-sectional area of the antenna aperture 522.

In certain embodiments, the antenna aperture is substantially (i.e., +/−20%) 170 mm wide. In certain embodiments, the antenna aperture is substantially (i.e., +/−20%) substantially (i.e., +/−20%) 3.8 mm tall. In certain embodiments, the antenna aperture is substantially (i.e., +/−20%) 2.0 mm deep.

In certain embodiments, the antenna component 520 is spaced substantially (i.e., +/−20%) 2.0 mm from the rear of the antenna aperture 522. In certain embodiments, the height of the antenna component 520 substantially (i.e., +/−20%) corresponds to an inside bottom edge of the display chassis when the display chassis is in an angled open orientation. In certain embodiments, the antenna component 520 is substantially (i.e., +/−20%) 6.0 mm tall and substantially (i.e., +/−20%) 6 mm deep. In certain embodiments, the width of the antenna component 520 is substantially (i.e., +/−20%) half of the width of the antenna aperture 522. In certain embodiments, the antenna carrier is substantially (i.e., +/−20%) 85 mm wide. In certain embodiments, the antenna radiator is substantially (i.e., +/−20%) 60 mm wide.

In certain embodiments, the antenna component 520 is positioned to substantially (i.e., +/−20%) correspond to a side of the antenna aperture 522. In certain embodiments, the antenna radiator is positioned to substantially (i.e., +/−20%) correspond to a side of the antenna carrier. In certain embodiments, the antenna component 520 is positioned to substantially (i.e., +/−20%) correspond to a right side of the antenna aperture. In certain embodiments, the antenna component is positioned to substantially (i.e., +/−20%) occupy a half side of the antenna aperture. In certain embodiments, the antenna component is positioned to excite the antenna aperture at the desired frequency band. In certain embodiments, the desired frequency band is substantially (i.e., +/−20%) 700-1000 MHz.

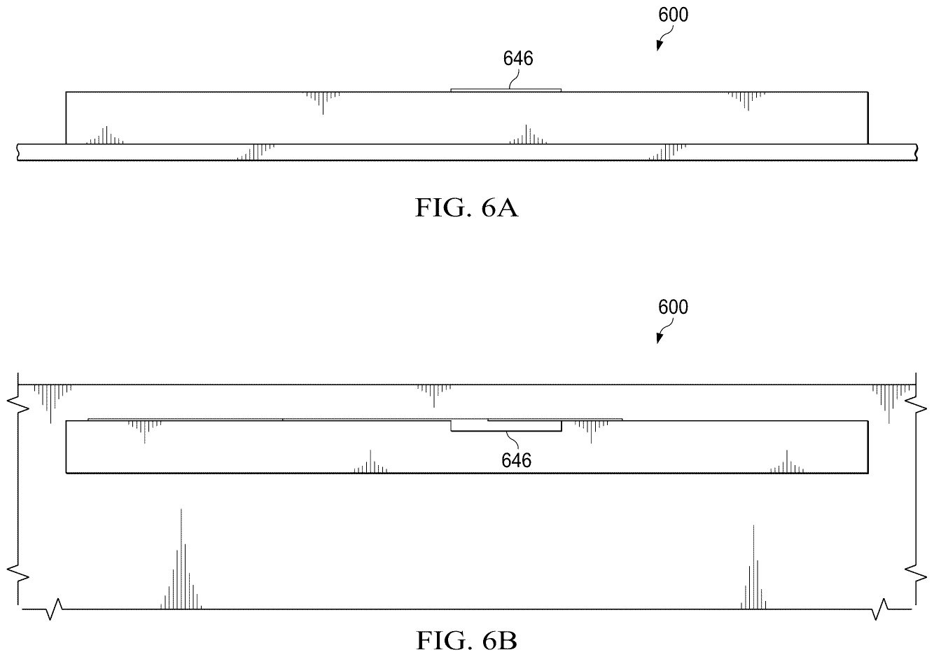

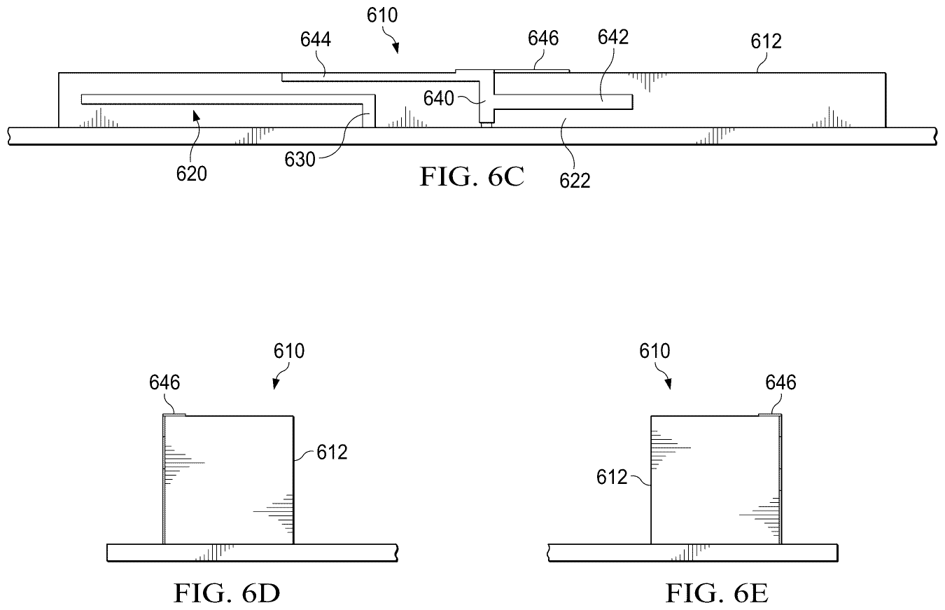

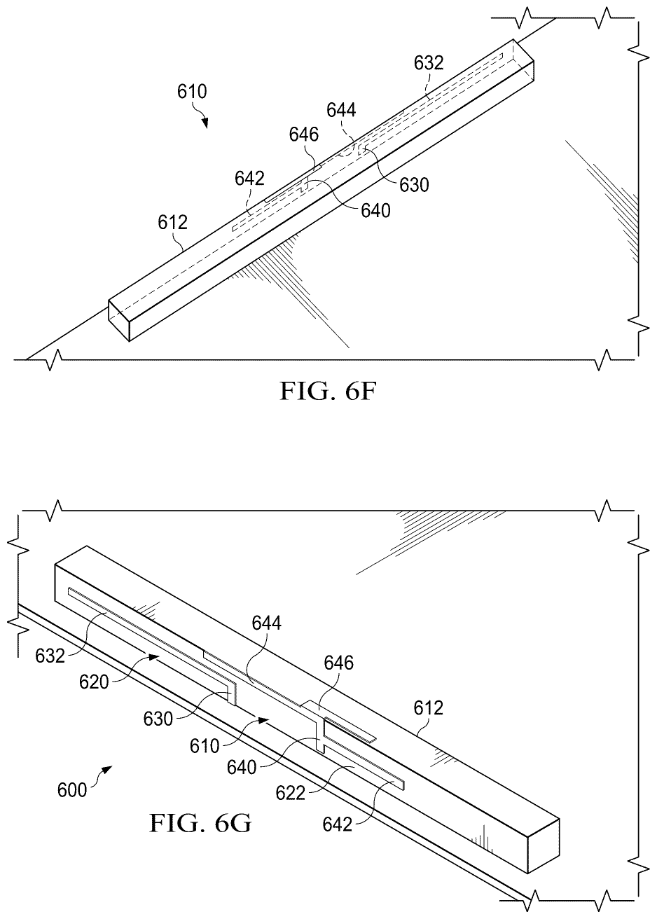

FIGS. 6A, 6B, 6C, 6D, 6E, 6F and 6G, generally referred to as FIG. 6, shows views of an antenna component 600 of an antenna system. FIG. 6A shows a front view of an antenna component 600 of an antenna system. FIG. 6B shows a top view of an antenna component 600 of an antenna system. FIG. 6C shows a rear view of an antenna component 600 of an antenna system. FIG. 6D shows a left side view of an antenna component 600 of an antenna system. FIG. 6E shows a right side view of an antenna component 600 of an antenna system. FIG. 6F shows a top rear perspective view of an antenna component 600 of an antenna system. FIG. 6G shows a top front perspective view of an antenna component 600 of an antenna system. In certain embodiments, antenna component 600 corresponds to the antenna component of antenna system 150.

In certain embodiments, the antenna component 600 includes an antenna radiator 610 and an antenna carrier 612. In certain embodiments, the antenna radiator 610 is positioned to substantially (i.e., +/−20%) correspond to a side of the antenna carrier 612. In certain embodiments, the antenna radiator 610 includes a first radiator element 620, a second radiator element 622, or a combination thereof.

In certain embodiments, the first radiator element 620 is mounted to a rear wall of the antenna carrier 612. In certain embodiments, the first radiator element 620 includes a vertical trace portion 630, a horizontal trace portion 632, or a combination thereof. In certain embodiments, the first radiator element 620 is substantially (i.e., +/−20%) L-shaped.

In certain embodiments, a portion of the second radiator element 622 is mounted to a rear wall of the antenna carrier 612. In certain embodiments, a portion of the second radiator element is mounted to a top wall of the antenna carrier 612. In certain embodiments, the second radiator element 622 includes a vertical rear trace portion 640, a first rear horizontal trace portion 642, a second rear horizontal trace portion 644, a top horizontal trace portion 646, or a combination thereof. In certain embodiments, the first rear horizontal trace portion 642 extends from a substantially (i.e., +/−20%) central side position of the vertical rear trace portion 640. In certain embodiments, the second rear horizontal trace portion 644 extends from a (i.e., +/−20%) substantially top side position of the vertical rear trace portion 640. In certain embodiments, the top horizontal trace portion 646 extends from a substantially top edge (i.e., +/−20%) of the vertical rear trace portion 640. In certain embodiments, the first rear horizontal trace portion 642 and second rear horizontal trace portion 644 extend from opposite sides of vertical rear trace portion 640. In certain embodiments, the first rear horizontal trace portion 642 and the top horizontal trace portion 646 extend substantially (i.e., +/−20%) parallel with each other.

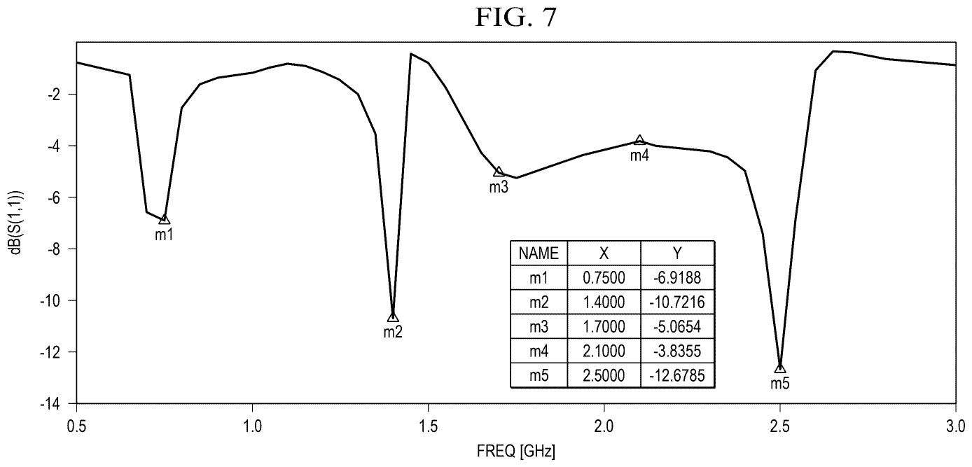

FIG. 7 shows an example performance result of an antenna system. More specifically, FIG. 7 shows an S-parameter result of an antenna system in accordance with the present disclosure. More specifically, the S-parameter result quantifies how signals and reflected, transmitted and passed via the antenna aperture of an antenna system such as antenna system 150.

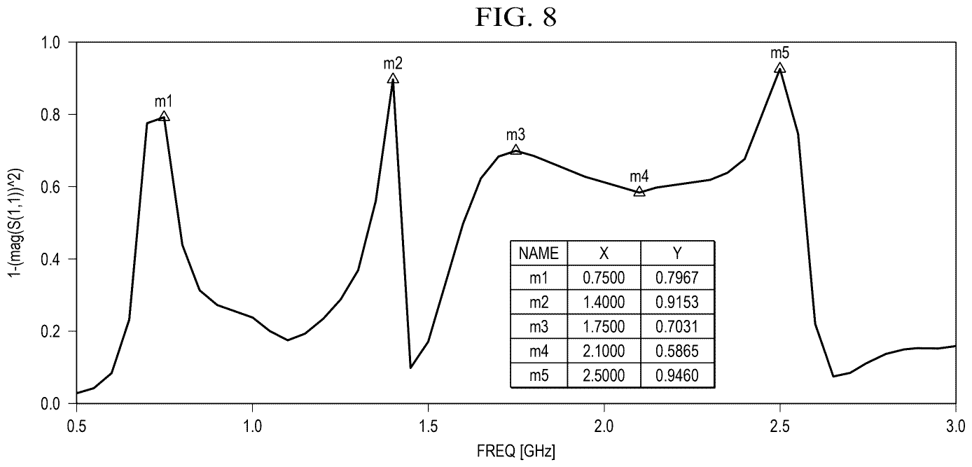

FIG. 8 shows an example performance result of an antenna system. More specifically, FIG. 8 shows an antenna efficiency result of an antenna system in accordance with the present disclosure. More specifically, the antenna efficiency result quantifies a ratio of radiated power to total power delivered to an antenna system such as antenna system 150.

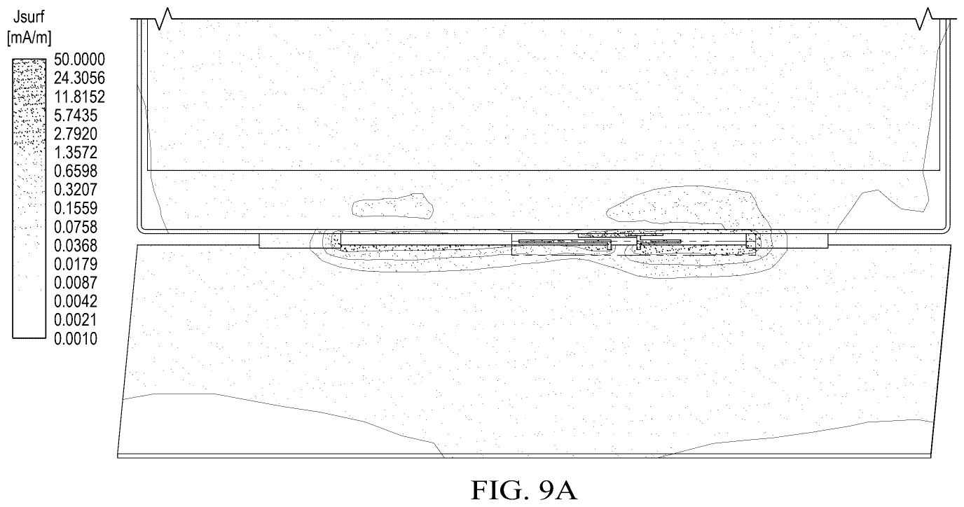

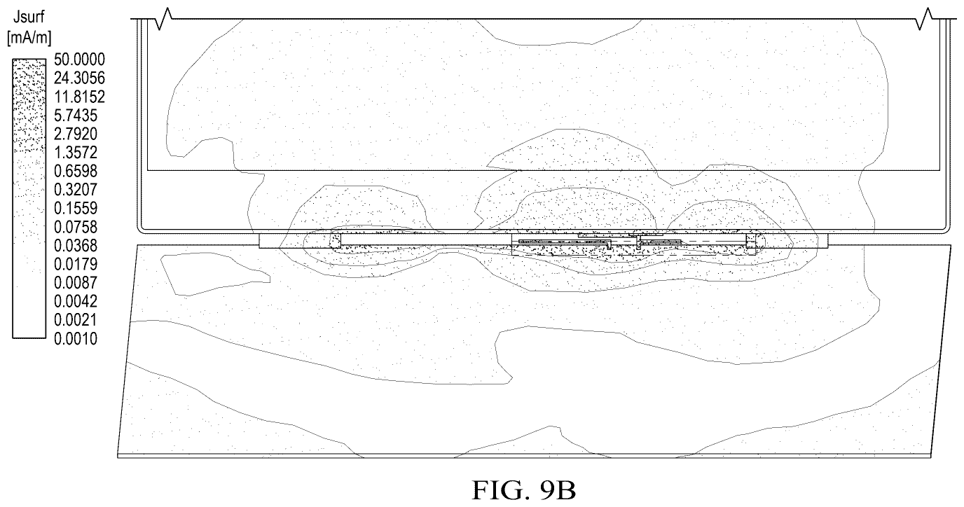

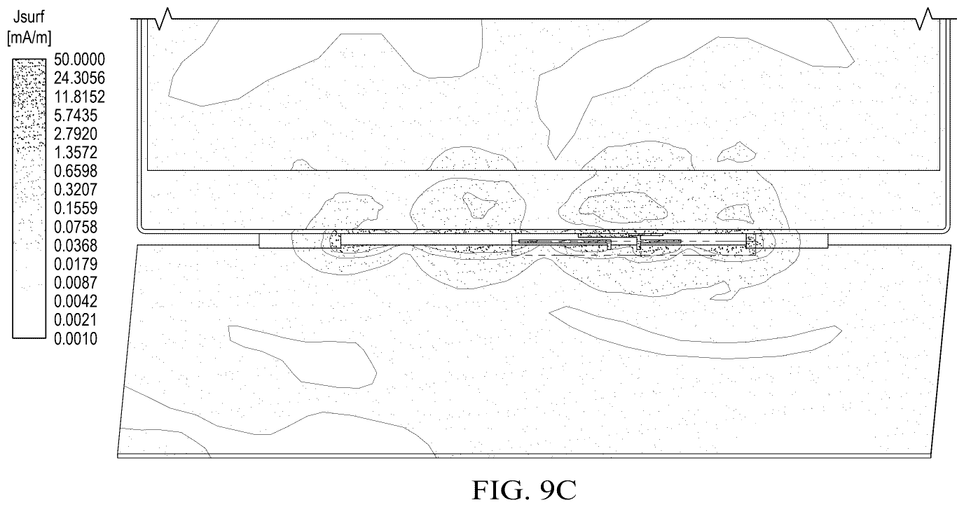

FIGS. 9A, 9B and 9C, generally referred to as FIG. 9, show example current distributions generated by an antenna system. More specifically, FIGS. 9A, 9B and 9C show example antenna system current distribution performance at a plurality of radio frequencies for an antenna system such as antenna system 150.

For example, FIG. 9A shows an example antenna system current distribution performance at a 0.75 GHz radio frequency (e.g., a 1 wavelength resonant close slot) for an antenna system such as antenna system 150. FIG. 9B shows an example antenna system current distribution performance at a 1.5 GHz radio frequency (e.g., a high order 2^{nd} harmonic resonance) for an antenna system such as antenna system 150. FIG. 9C shows an example antenna system current distribution performance at a 2.25 GHz radio frequency (e.g., a high order 3^{rd} harmonic resonance) for an antenna system such as antenna system 150.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. An antenna system for a portable information handling system, comprising:
an antenna aperture, the antenna aperture horizontally extending between hinges of the portable information handling system; and,
an antenna component, the antenna component horizontally extending across a portion of the antenna aperture, the antenna aperture and the antenna component being configured as a slot antenna.

2. The antenna system of claim 1, wherein:
the antenna aperture is defined by an A cover and a D cover of the portable information handling system.

3. The antenna system of claim 1, wherein:
the antenna component includes an antenna radiator and an antenna carrier, the antenna radiation being mounted on the antenna carrier.

4. The antenna system of claim 1, wherein:
the antenna component is positioned to substantially correspond to a side of the antenna aperture.

5. The antenna system of claim 4, wherein:
the antenna component horizontally extends across substantially half of the antenna aperture.

6. The antenna system of claim 1, wherein:
the antenna component excites the antenna aperture at a frequency band between substantially 700 Mhz and 1000 MHz.

7. An information handling system comprising:
a processor;
a data bus coupled to the processor; and
a chassis housing, the chassis housing comprising
a base chassis, the base chassis housing the processor; and
a display chassis, the base chassis and the display chassis being attached via a plurality of hinges; and,
an antenna system coupled to the processor, the antenna system comprising
an antenna aperture, the antenna aperture horizontally extending between the plurality of hinges; and,
an antenna component, the antenna component horizontally extending across a portion of the antenna aperture, the antenna aperture and the antenna component being configured as a slot antenna.

8. The information handling system of claim 7, wherein:
the antenna aperture is defined by an A cover and a D cover of the portable information handling system.

9. The information handling system of claim 7, wherein:
the antenna component includes an antenna radiator and an antenna carrier, the antenna radiation being mounted on the antenna carrier.

10. The information handling system of claim 7, wherein:
the antenna component is positioned to substantially correspond to a side of the antenna aperture.

11. The information handling system of claim 10, wherein:
the antenna component horizontally extends across substantially half of the antenna aperture.

12. The information handling system of claim 7, wherein:
the antenna component excites the antenna aperture at a frequency band between substantially 700 Mhz and 1000 MHz.
